(19) United States
(12) Patent Application Publication
(10) Pub. No.: US 2007/0024057 A1
(43) Pub. Date: Feb. 1, 2007

(54) Conduit assembly and method of making same

(76) Inventor: Jaswinder Sehmbi, Caledon East (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 11/191,241

(22) Filed: Jul. 28, 2005

(51) Int. Cl. F16L 25/00

(52) U.S. Cl. 285/386

(57) ABSTRACT

A conduit assembly and method of making same is disclosed. The conduit assembly may include a retainer and a fitting. The fitting may have an accommodation in the nature of a rebate. A conduit having an end may be axially inserted into the accommodation. The accommodation may have a portion defining a profile of varying radius as a function of axial location. The conduit end may conform to a radially inner surface of the accommodation, and the retainer may conform to a radially outer surface of the accommodation and to the end, in order to retain the end within the accommodation.

### FIELD OF THE INVENTION

The present invention relates to a conduit assembly, and particularly relates to a connection assembly to join a fluid carrying conduit to a fitting such as may be used in a gas fueled appliance.

### BACKGROUND OF THE INVENTION

It is often desirable to join a conduit, such as a tube for carrying a fluid such as gas, to a fitting, such as a manifold assembly. This has been done in a number of different ways. Such arrangements appear to be concerned with imparting a force to the conduit to cause numerous deformations in the body of the conduit while leaving the conduit end intact. The deformed area along the length of the tube appears to be required to further hold the fitting and conduit in engaged relation.

Other known assemblies may employ a co-axial cylindrical threading applied to either the fitting or the conduit in order to seal the connection therebetween.

Accordingly, there is a need for alternative conduit assemblies.

### SUMMARY OF THE INVENTION

In accordance with a broad aspect of the present invention there is provided a conduit assembly including a retainer, a fitting having an accommodation, and a conduit having an end axially inserted into the accommodation. The accommodation may have a portion defining a profile of varying radius as a function of axial location, and the end may conform to a radially inner surface of the accommodation. The retainer may conform to a radially outer surface of the accommodation and to the end to retain the end within the accommodation.

In an embodiment, the outer surface may have a generally round cross-section to define generally cylindrical shape, and the radially inner surface has the profile of varying radius.

In a further embodiment, the accommodation may include an opening for receiving the end, and the radius generally increases along the axis of insertion along the direction of insertion.

In a further embodiment, the radius varies orthogonally to the axis.

In a further embodiment, the retainer is threaded and the accommodation defines threads complimentary to the retainer threads for engaging the retainer.

In a yet further embodiment, he retainer is frictionally retained within the accommodation.

Conveniently, the accommodation may be a rebate and the radially inner surface may be conically shaped being narrower adjacent the opening, and the end may be flared to conform to the conical inner surface.

In a further embodiment, the radially inner surface is frusto-conically shaped.

In a further embodiment, the retainer is a ring that is tapered, being narrower at a leading end of insertion thereof.

In a further embodiment, the ring is a wedge.

In a further embodiment, the conduit has a diameter in the range of ⅛ of an inch to 1.5 inches.

In a further embodiment, the fitting further defines a passage therein, the passage being located for fluid communication with the conduit.

In a further embodiment, the conduit is a tube.

In a further embodiment, the assembly is deformed adjacent an interface of the retainer and the fitting to retain the fitting within the accommodation.

In a further embodiment, the assembly is swaged adjacent an interface of the retainer and the fitting to retain the fitting within the accommodation.

In a further embodiment, the assembly is indented adjacent an interface of the and the fitting to retain the fitting within the accommodation.

In a further embodiment, at least one of the conduit end, the retainer, and the fitting are made of at least one material selected from the group consisting of: aluminum, aluminum alloy, stainless steel copper, brass and mild steel.

In a further embodiment, the fitting is a bulkhead adapter.

In accordance with another broad aspect of the present invention there is provided a conduit assembly including a conduit having an end made of a ductile material, and a fitting having an accommodation. The conduit end may be axially inserted into the accommodation, and the accommodation is shaped to compel deformation of the end during insertion thereof. The accommodation may have a portion defining a profile of varying radius as a function of axial location, and the end may be deformed to conform to the profile to be retained within the accommodation.

In a further embodiment, the accommodation includes an opening for receiving the end, and the radius generally increases along the axis of insertion along the direction of insertion.

In a yet further embodiment, the assembly is deformed adjacent an interface of the conduit and the fitting to retain the fitting within the accommodation.

In a further embodiment, the assembly is swaged adjacent an interface of the conduit and the fitting to retain the fitting within the accommodation.

In a further embodiment, the assembly is indented adjacent an interface of the conduit and the fitting to retain the fitting within the accommodation.

In a further embodiment, the fitting is made of a material that is harder than the material of the conduit end.

In a further embodiment, the accommodation defines a conically shaped rebate.

In a further embodiment, the conduit end is made from a material selected from the group consisting of: aluminum, aluminum alloy, stainless steel copper, brass, mild steel and plastic.

In accordance with another broad aspect of the present invention there is provided conduit assembly including a retainer, a fitting having an accommodation, and a conduit having an end axially inserted into the accommodation. The accommodation may have a profile of constant radius as a function of axial location. The end may extend proud of an outer surface of the conduit, and the retainer may conform to a radially outer surface of the accommodation and to the conduit outer surface. The assembly may be deformed adjacent an interface of the retainer and the fitting to retain the end within the accommodation.

In a further embodiment, the assembly is swaged adjacent an interface of the conduit and the fitting to retain the fitting within the accommodation.

In a further embodiment, the assembly is indented adjacent an interface of the conduit and the fitting to retain the fitting within the accommodation.

In accordance with another broad aspect of the present invention there is provided a method of joining a conduit to a fitting. The conduit may have an end extending proud of an outer surface of the conduit, and the fitting may have an accommodation. The method includes the steps of: inserting the conduit into the accommodation; placing into the accommodation a retainer which conforms to a radially outer surface of the accommodation and to the conduit outer surface; and deforming the assembly adjacent an interface of the retainer and the fitting to retain the end within the accommodation.

In accordance with another broad aspect of the present invention there is provided a method of joining a cylindrical conduit to a fitting. The fitting may have a conically shaped accommodation, and the accommodation may have a portion defining a profile of varying radius as a function of axial location. The method includes the steps of: axially inserting the conduit into the accommodation to deform the conduit end to a conical shape; and deforming the assembly adjacent an interface of the conduit and the fitting to retain the end within the accommodation.

Other and further advantages and features of the invention will be apparent to those skilled in the art from the following detailed description of embodiments thereof, taken in conjunction with the accompanying drawings.

### BRIEF DESCRIPTION OF THE FIGURES

The present invention will be further understood from the following detailed description of an embodiment of the invention, with reference to the drawings in which:

FIG. 1 illustrates in perspective view, a conduit assembly in accordance with an embodiment of the present invention;

FIG. 2 is an exploded perspective view of the conduit assembly of FIG. 1 prior to the insertion of the conduit;

FIG. 3 is a sectional view of the assembly along the lines 3-3 of FIG. 1 showing the conduit after insertion;

FIG. 4 illustrates the connection assembly of FIG. 3 wherein the area about the interface of the conduit in the fitting has been deformed;

FIG. 5 is a side sectional view of the assembly showing the conduit material inserted into the rebate;

FIG. 6A is a side partially exploded cross-sectional view of an alternative embodiment of the assembly having a threaded connection;

FIG. 6B is a assembled view of the assembly of FIG. 6A;

FIG. 7 is an isolated perspective view of two parts of a conduit holder shown in an open position;

FIG. 8 is a side sectional view showing a conduit held by the holding assembly of FIG. 7 prior to insertion into a fitting;

FIG. 9 illustrates the arrangement of FIG. 8 having the conduit inserted into the fitting;

FIG. 10 illustrates the assembly of FIG. 8 wherein the conduit is inserted into the fitting and the holding assembly is in abutting relationship with the fitting;

FIG. 11 is a side partially exploded cross-sectional view of an alternative embodiment of the assembly;

FIG. 12 is a assembled view of the assembly of FIG. 11;

FIG. 13 illustrates a side sectional view of an alternative fitting rebate configuration;

FIG. 14 illustrates a further alternative embodiment of a fitting rebate;

FIG. 15 illustrates a further alternative embodiment of a fitting rebate;

FIG. 16 illustrates a further alternative embodiment of a fitting rebate;

FIG. 17 illustrates a further alternative embodiment of a fitting rebate;

FIG. 18 illustrates a further alternative embodiment of a fitting rebate;

FIG. 19 illustrates a cross section of an alternative embodiment of a fitting assembly wherein the fitting rebate is located internal to the fitting;

FIG. 20 is a side cross sectional view of an alternative embodiment of the assembly wherein the fitting does not include a passage therethrough;

FIGS. 21A and B illustrates an alternative embodiment of the conduit having a different wall thicknesses;

FIGS. 22A and B illustrate an alternative embodiment of the conduit having a modified end;

FIG. 23 illustrates a further alternative embodiment of the conduit having a modified end;

FIG. 24 illustrates an alternative embodiment of the conduit having a rounded end;

FIGS. 25A, B and C illustrate a cross-sectional view of illustrating the steps in providing the rebate in the bulkhead;

FIG. 26 illustrates an alternative embodiment of the conduit having a tabbed end;

FIG. 27 illustrates a farther alternate embodiment of the rebate having a stepped-conical shape;

FIG. 28 illustrates a further embodiment of the rebate which includes a threaded portion on an outer diameter of the rebate;

FIG. 29 illustrates a further embodiment of the rebate which includes a threaded portion on an inner diameter of the rebate;

FIG. 30 illustrates dimensions of an embodiment of the assembly.

FIG. 31 illustrates in perspective view, a conduit assembly in accordance with an embodiment of the present invention;

FIG. 32 illustrates in perspective view, the conduit assembly of FIG. 31 having a deformed periphery;

FIG. 33 is an exploded sectional perspective view of the conduit assembly of FIG. 31 prior to the insertion of the conduit;

FIG. 34 is a sectional view of the assembly along the lines 41-41 of FIG. 31 showing the conduit after insertion;

FIG. 35 illustrates a sectional view of the connection assembly of FIG. 34 taken along the lines 42-42 of FIG. 32, wherein the area adjacent the interface of the conduit in the fitting has been deformed;

FIG. 36 is a side sectional view of the assembly of FIG. 34 showing the conduit material inserted into the rebate;

FIG. 37 is a side sectional view of the assembly of FIG. 35 showing the conduit material inserted into the rebate with portions of the fitting being deformed;

FIG. 38 is an isolated perspective view of two parts of an embodiment of a conduit holder shown in an open position;

FIG. 39 is a side sectional view of the assembly of FIG. 33 prior to insertion into a fitting;

FIG. 40 illustrates the arrangement of FIG. 39 having the conduit inserted into the fitting;

FIG. 41 illustrates the assembly of FIG. 39 wherein the conduit is inserted into the fitting and the holding assembly is in abutting relationship with the fitting; and

FIG. 42 illustrates dimensions of an embodiment of the assembly.

### DETAILED DESCRIPTION OF THE INVENTION

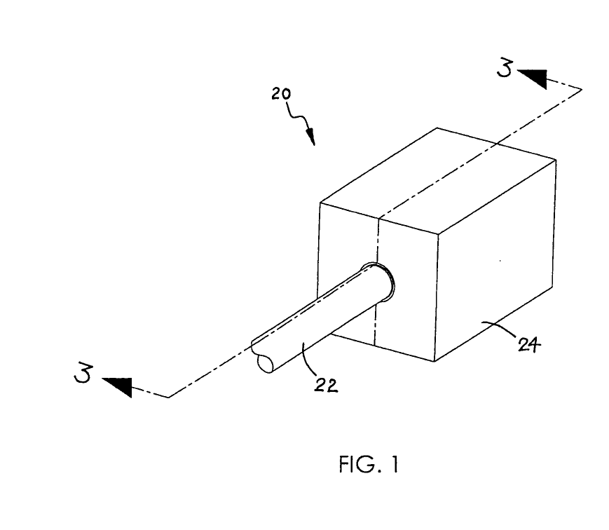

Similar references are used in different figures to denote similar components. FIG. 1 illustrates in perspective view a conduit assembly 20 in accordance with an embodiment of the present invention. Assembly 20 includes a conduit 22 and a fitting 24. Conduit 22 may be used to carry a fluid such as a liquid or a gas, and communicates with fitting 24 to transfer such fluid to and/or from fitting 24. For example, conduit 22 may be a tube or a pipe (including welded seamless pipe), or some other hollow feature for conveying a fluid or to function as a passage. If welded seamless pipe is used then it may be hydrostatically tested before use to ensure that it will not leak.

Conduit 22 may be a tube that forms part of a gas fueled appliance, or burner assembly. For example, it may be used to channel combustion fluid such as natural gas and propane gas in a gas train manifold, and may include a burner of a stove or fireplace. It is expected that this arrangement may be used to carry a liquid such as water. The fluid going through conduit 22 and bulkhead 24 is preferably compatible with the material chosen to fabricate the parts (e.g., a material resistant to water corrosion may be used if water is to be contained within assembly 20). Fitting 24 may be a manifold or other part for distributing a gas such as propane, butane, or natural gas. It is expected that the various embodiments of the conduit assembly and methods for making the conduit assembly may be used in a multitude of applications, which are not necessarily limited to burner assemblies.

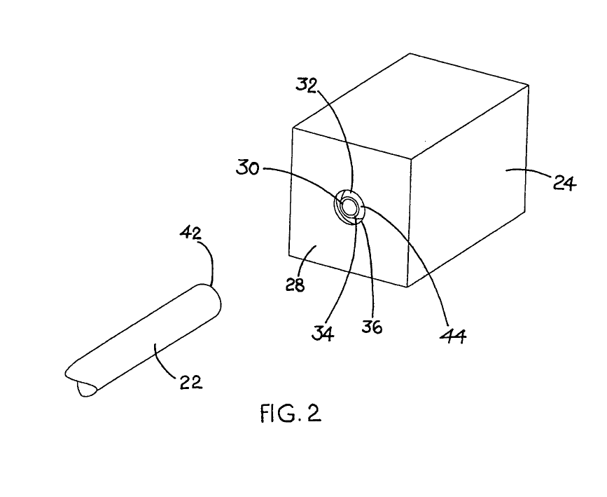

As shown in FIG. 2, conduit 22 may be in the form of a pipe or tube and fitting 24 may be a bulkhead or bulkhead adapter. Fitting 24 may be some other component of a system involving fluids, for example, fitting 24 could be a manifold, a conduit (for example having an inner diameter smaller than conduit 22 and an outer diameter larger than conduit 22, as shown in FIG. 13), or an end plug for conduit 22 (see, for example FIG. 20). Similarly, conduit 22 may have a bend or curve formed therein. For ease of illustration, conduit 22 will be referred to in the present embodiment as tube 22, and fitting 24 will be referred to as bulkhead 24.

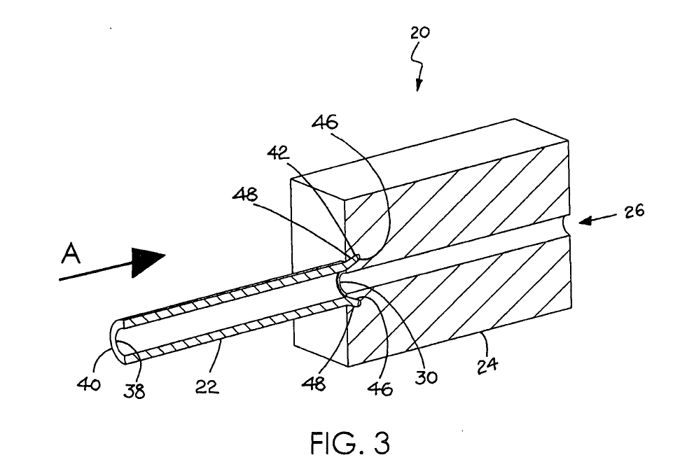

As shown in FIGS. 2 and 3, bulkhead 24 includes a passage 26 for transporting a fluid. Bulkhead end 28 may have an opening 30 to passage 26. Once assembled, passage 26 may be in fluid communication with tube 22. Passage 26 may be used to transfer a fluid between tube 22 and part of an assembly requiring such fluid for its operation (not shown). Bulkhead 24 is shown as rectangular, but it may be any appropriate shape such as polygonal, round or an irregular shape.

An accommodation, such as a generally conical rebate 32, may be formed in bulkhead 24 to retain tube 22 therein. Portions of bulkhead 24 that define rebate 32 may co-operate with tube end 42 to provide a fluid tight seal therebetween. Rebate 32 may extend away from passage 26 as it progresses into bulkhead 24 from end 28. At bulkhead end 28, rebate 32 may have an inner diameter 34 and an outer diameter 36 that approximately correspond to the respective inner diameter 38 and outer diameter 40 of tube 22. It will be appreciated that rebate 32 may have numerous other configurations in other embodiments, including other generally annular configurations, as will be explained later.

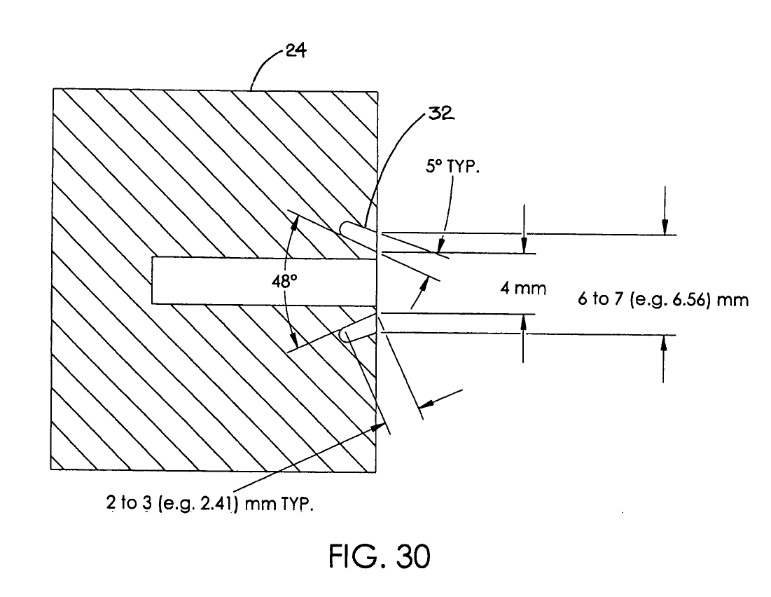

In the present embodiment, bulkhead inner diameter 34 is marginally smaller than tube inner diameter 38 and bulkhead outer diameter 36 is marginally larger than tube outer diameter 40. This arrangement permits an end 42 of tube 22 to be placed at a mouth 44 defined by rebate 32. A thickness of tube 22 defined by inner diameter 38 and outer diameter 40 need not be entirely uniform. For example, as shown in FIG. 30, inner diameter 38 may be about 4 mm and outer diameter 40 may be about 6.56 mm. Depending upon the material used, a tube wall thickness may be as thin (or depending upon the material thinner) as 5 mil and as thick or thicker than about ⅛ of an inch. Similarly, the surfaces defined by inner diameter 34 and outer diameter 36 may vary to some extent provided that tube end 42 may be deformably introduced therein to be retained by bulkhead 24 and/or to create a seal with bulkhead 24 after a force is applied to tube 22 as it is introduced into rebate 32. Rebate 32 may have a depth of about 2 to 3 mm, or more, and may form an angle of about 5 to about 90 degrees with a central axis of passage 26, so long as tube end 42 is encourage to deform therein. An angle in the range of 35 to 55 degrees may also be suitable, depending upon the dimensions used. Furthermore, rebate inner and outer surfaces 46 and 48 may be generally parallel or they may be angled relative to one another. For example, they may be angled at about 5 degrees relative to one another so that month 44 is the widest portion of rebate 32.

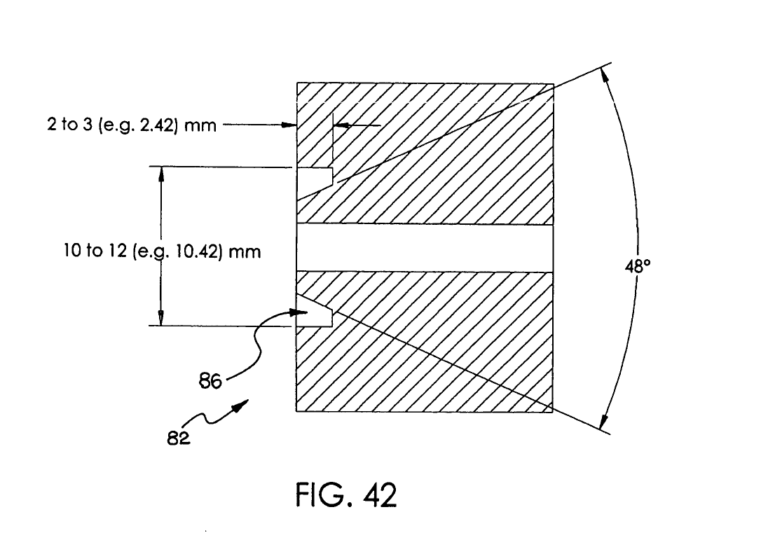

The dimensions shown in FIGS. 30 and 42 are for selected embodiments. As noted, numerous other dimensions and combinations of inventions may be suitable as well. For example, if a 1½″ diameter conduit 22 is used, the dimensions illustrated in FIGS. 30 and 42 may not be as suitable, and may not work in conjunction with such tube.

For example, the size of conduit end flare may be proportional to the outside diameter of conduit 22. For example, for a ¼ inch diameter conduit, the flare may extend at least in the range of about 0.2 to ¼ inches (flare length is the dimension of the conduit end that is substantially parallel to a longitudinal axis of the conduit). Therefore, the length of the flare may be about the same as the diameter. This ratio may vary somewhat, and may depend upon the material used and the dimensions of the components of assembly 20 such as the angle of rebate 32.

The angle of the rebate may depend to some extent on the wall thickness of the conduit. For example, if the angle is too large, the conduit end may split or weaken as a result if the material of the conduit is too thin.

It is noted that the dimensions provided herein for the various embodiments of the inventions described may be varied, and may be advantageously varied to satisfy at least the following operating conditions: i) the operating temperature of the assembly 20; ii) the fluid flow rate requirements; iii) the type of fluid to be carried; and iv) the pressure to be contained by the assembly 20. Changes in these conditions may require changes in the dimensions disclosed herein. For example if a greater flow rate is required, then a tube having a larger inner diameter may be employed.

In the present embodiment, tube end 42 has an outer diameter 40 in the range of about ⅛ of an inch to two inches. Nearly any other diameter is expected to be suitable as well. Tube end 42 may be cut fairly straight, clean, and free of burrs. Similarly, the inner diameter and outer diameter of the tube end may be deburred prior to assembly. The cut end of the tube may be generally parallel with the mating surface of the rebate. The foregoing applies to at least one of the embodiments, however, examples of variants are disclosed below.

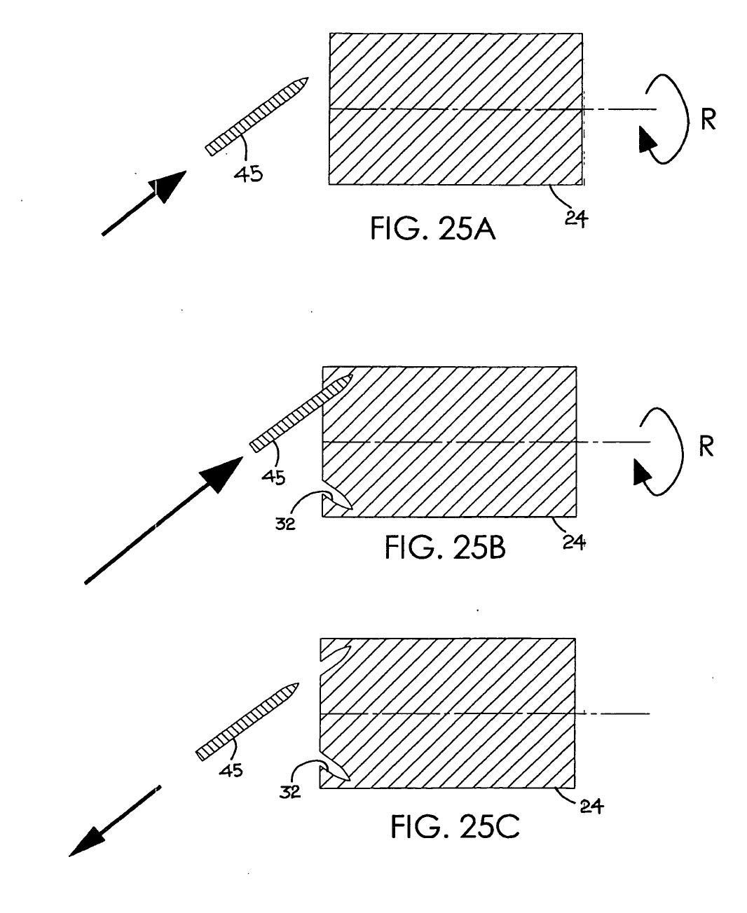

Rebate 32 of bulkhead 24 may be made using a specialized tool. FIGS. 25A, B and C illustrate how rebate 32 may be made. Bulkhead 24 may be rotatably mounted to a lathe (not shown). A pin-shaped cutting tool 45 may be positioned at an angle from the rotating axis. For example, an angle of about 24° may be used. As the lathe turns, pin-shaped cutting tool 45 is brought into contact with bulkhead 24. The depth of the rebate is dictated by how far pin-shaped cutting tool 45 moves inward of bulkhead 24. A depth of two or more millimeters may be used.

As bulkhead 24 rotates (for example in direction R), pin tool 45 may be moved along axis D to engage and form rebate 32.

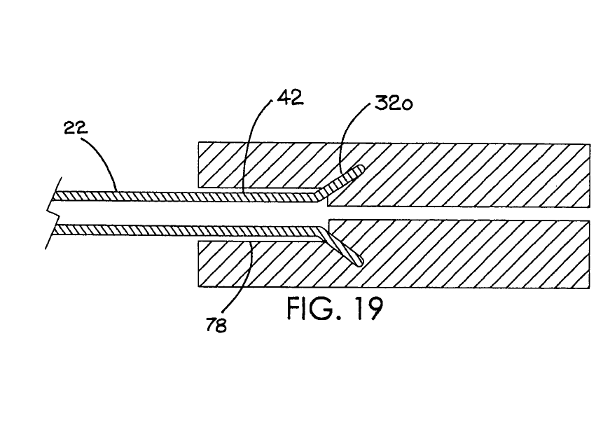

Depending on the configuration of rebate 32, tube 22 may be placed adjacent rebate 32, or marginally within rebate 32 (in alternative embodiments, further insertion of tube end 42 may be permitted, as illustrated in FIG. 19).

Referring again to FIG. 3, force may be applied to tube 22 generally along direction A to encourage it to move generally along its axis in the direction A so that it enters rebate 32. Portions of bulkhead 24 which define conical rebate 32 may then engage tube end 42. As the force is applied, tube end 42 deforms, and may plastically deform, as it enters rebate 32. To encourage such deformation, tube end 42 may be made of a relatively inexpensive ductile material such as aluminum, or any other suitable malleable material. Alternatively, other materials such as stainless steel, copper, brass, mild steel, ductile iron, gold, silver or some other suitable material or alloy may be used. It should be appreciated that these are merely examples of materials that can be used.

Bulkhead 24 may be made of a similar material, and is preferably made of a material at least as hard as the material used for tube end 42 (the entire tube 22 and bulkhead 24 may be made of the same material). In the present embodiment, bulkhead 24 may be made of a material at least as hard as the material used for tube 22. The possible difference in materials between bulkhead 24 and tube 22 may permit bulkhead 24 to resist deformation when tube 22 is introduced to rebate 32, while at the same time providing sufficient resistance to permit tube end 42 to deform. If bulkhead 24 and tube end 42 are made of materials of similar hardness, then rebate 32 may be made slightly larger than tube end 42 to limit or eliminate any significant deformation of bulkhead 22. It should be noted that bulkhead 24 may be uniform both in the materials used and in being a single component. Alternatively, bulkhead 24 may be made of multiple parts, and may be made of different materials, provided that portions of bulkhead 24 that define rebate 32 are made of a suitable material to resist and engage tube 22, while at the same time providing sufficient resistance to permit tube end 42 to deform. Fitting 24 need not be made of the same material as conduit 22.

As shown in FIGS. 3 and 4, tube 22 encounters portions of bulkhead 24 adjacent to rebate inner diameter 34. As force is applied to tube 22 in direction A, tube inner diameter 38 encounters sides 46 defining the inner diameter surface of rebate 32. Sides 46 encourage deformation of tube end 42 in a generally radially outward direction. The generally ductile material of tube 22 tends to expand, or flare, and fills at least a portion of rebate 32 to substantially create a seal at the interface between tube 22 and bulkhead 24. A broad range of wall thicknesses for tube 22 may be used. For example, a tube having a diameter of between about ⅛ of an inch and 1.5 inches would be suitable (while imperial dimensions are provided in the description herein, metric and other sizes may also be employed). Other dimensions would be expected to work as well. It is possible that tubes having very thin walls or dimensioned below ⅛ of an inch diameter might experience cracking when used as disclosed herein. Similarly, tube walls that are too thick might be more resistant to deformation. The seal resists the release of a fluid, whether liquid or gas, depending on the embodiment used, passing between tube 22 and bulkhead 24. The seal formed may be a low pressure seal, and may not be ideally suited to high pressure environments. For example, the seal may resist pressures of around 14 psig (and may be suitable for carrying a propane gas), and may be configured to resist pressures in the range of about 0 to 100 psig.

The deformation of tube end 42 frictionally engages one or both of rebate inner diameter surface 46 and rebate outer diameter surface 48 to inhibit fluid leakage. After deformation, sides 48, which define an outer diameter of the bulkhead surface defining rebate 32, may inhibit removal of tube 22 in a direction opposite that to direction A. Tube end 42 may be retained by bulkhead 24 without directly affecting the structure of passage 26. In many embodiments, tube end 42 is retained in an area beyond the walls of passage 26.

If suitable materials are used, a cold weld may form between tube 22 and bulkhead 24. For example, materials such as an aluminum cleaned substantially of oxides at the interface surfaces between tube 22 and bulkhead 24 may be used. Furthermore, the bulkhead 24 and tube 22 are made of copper, for example, two pieces may be soldered along an interface there between. Alternatively (or additionally), tube end 42 may be dipped in a bonding adhesive such as an epoxy prior to the insertion of tube 22. The bonding adhesive will encourage a chemical bond to form between tube 22 and bulkhead 24. Crimping, swaging or other deformation (described below) may not be necessary.

FIG. 4 illustrates a deformation caused in at least bulkhead 24 to further encourage retention of tube 22 within bulkhead 24, and the sealing of the interface between tube end 42 and bulkhead 24. Such deformation generally occurs about the intersection 50 of tube end 42 and bulkhead 24. Such deformation may cause portions of bulkhead 24 adjacent intersection 50, labeled 52, to further compress tube end 42, or at least tightened the fit between tube end 42 and bulkhead 24. Portions of tube end 42 adjacent interface 50 may also be deformed to further compress tube end 42 into rebate 32. Such deformation in area 50 may take the form of crimping, swaging, binding, striking or some other deformation. In the present embodiment, the deformed area about 50 has a generally annular shape which generally follows the outer perimeter of tube 22. Other uniform or non-uniform deformations (not shown) such as sequential or intermittent deformations made to bulkhead 24 or adjacent the outer circumference of tube 22, or deformations made in and/or adjacent area 50 may also be employed.

Tube 22 may be frictionally retained within rebate 32 without swaging. However, additional retention may be provided by swaging, crimping or otherwise deforming as set out herein. Greater deformation of tube 22 and/or bulkhead 24 may increase the extent to which tube 22 may be retained.

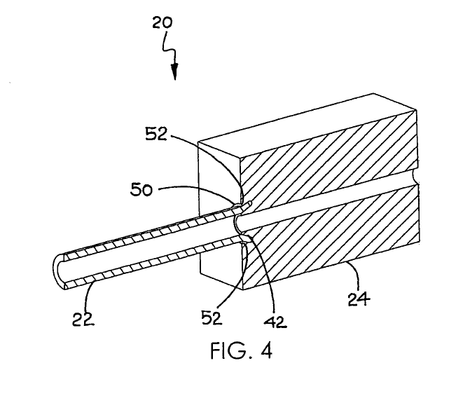

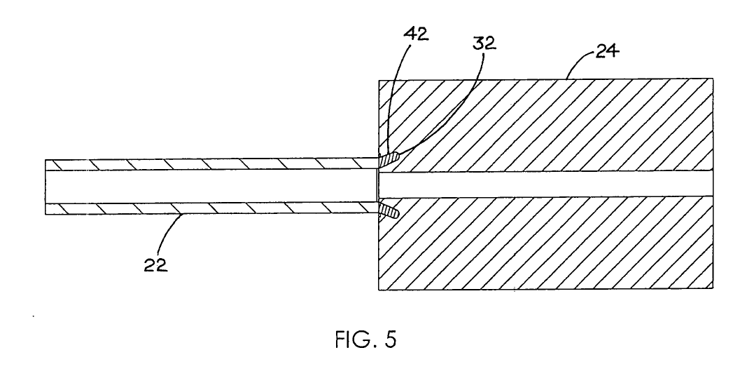

FIG. 5 illustrates a tube 22 having tube end 42 deformed to substantially completely fill rebate 32. It should be noted that this arrangement may be expected to further inhibit release of a fluid at the interface between tube 22 and bulkhead 24.

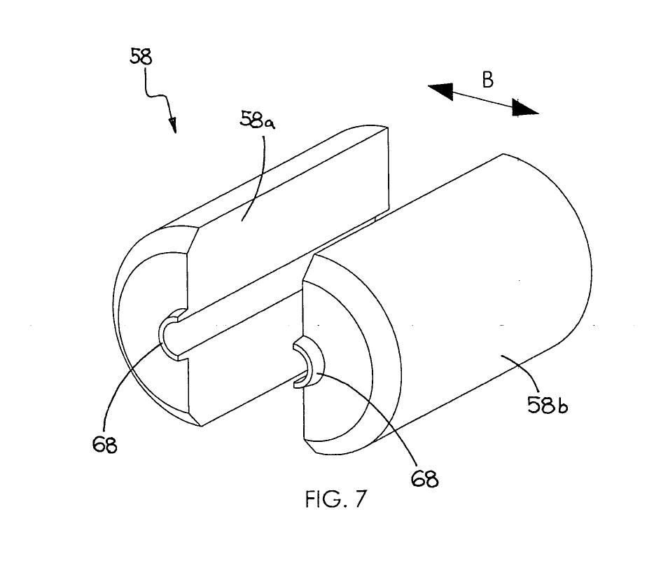

An apparatus (not shown) may be used to assemble tube 22 and bulkhead 24. Bulkhead 24 may be held in place by a bulkhead holder. The holder generally has a negative contour (not shown) of a portion of bulkhead 24, and the holder preferably inhibits rotation of bulkhead 24 once bulkhead 24 is placed within the bulkhead holder. Bulkhead 24 may be placed in the bulkhead holder with rebate 32 facing a tube holder which may include a split jaw assembly having opposed parts 58a and 58b. Tube holder 58 is shown in FIG. 7. Each part 58a and 58b of tube holder 58 is movable along the axis shown by B in FIG. 7. Parts 58a and 58b may be moved towards each other along axis B to abut and hold a tube 22. Aspects of the apparatus are described mainly in the context of a generally straight tube 22. Modifications may be made to components of the apparatus, as necessary to accommodate other shapes and sizes of conduit such as conduits having bends or curves formed therein.

In the present embodiment, the pressure exerted on tube 22 by parts 58a and 58b may be pre-adjusted by adjusting a linkages between parts 58a and 58b and a cam or other suitable feature. Adjustment of such pressure exerted on tube 22 may be required so that tubes of different hardnesses may be employed without bending identity or otherwise undesirably deforming portions of tube 22.

In operation, the apparatus may be activated by a pneumatic assembly. Pneumatics may be activated to move a tube holder support assembly generally toward the bulkhead holder. As the support assembly is moved, the cam may engage a guide which encourages tube holder parts 58A and 58B to move generally towards each other in direction B to grip tube 22. Pneumatics may encourage the support assembly to generally move towards the bulkhead holder, which holds bulkhead 24.

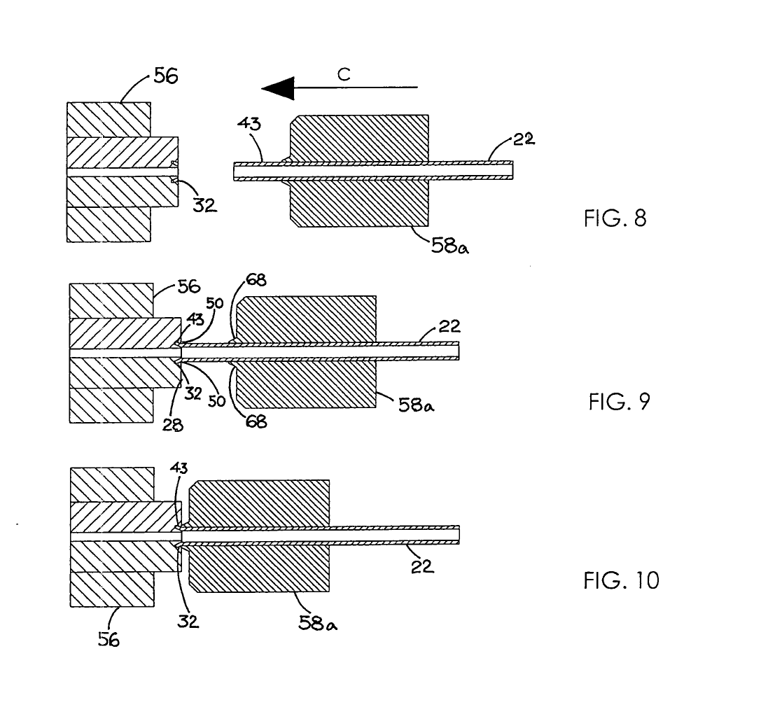

Referring additionally to FIGS. 8, 9 and 10, tube 22 is placed in tube holder 58 so that tube end 42 my extend by a limited amount, for example ¼ of an inch, beyond tube holder 58. As tube 22 is advanced, tube end 42 encounters the mouth of rebate 32 and engages at least one of rebate internal diameter 34 and rebate external diameter 36. Further insertion of tube end 42 causes tube end 42 to deform into rebate 32, as described above. Once such deformation is substantially complete, tube holder 58 begins to slip or slide along tube 22 in direction C. Tube 22 may be gripped by holder 58 by applying a force of about 50 psi, and in the range of just over 0 to 300 psi or more depending upon the material used and the wall thickness of tube 22. At this stage, tube 22 and bulkhead 24 are substantially connected to each other and may provide a satisfactory seal against seepage or leakage of a fluid carried by assembly 20.

The retention of tube end 42 within rebate 32 may be further encouraged by permitting tube holder 58 to slip or slide along tube 22 until it strikes bulkhead end 28 in the general area 50 to deform or crimp at least some portions of bulkhead end 28 adjacent tube 22. Striking may be done one or more times depending upon the force used. Additional strikes may encourage further deformation.

To facilitate such deformation, a tooling feature, in the nature of a crimping or swaging tool having, for example, a bull nose 68, is provided on tube holder 58 and is located to be positioned adjacent or about the outer circumference of tube 22 adjacent tube end 42. Bull nose 68 in the present embodiment may be a circumferential protrusion or projection of sufficient hardness to deform the material of bulkhead 24 in area 50.

The steps including the insertion of tube 22 into rebate 32, and the striking by bull nose 68 may be done in one generally continuous motion. Alternatively, the steps may be done discretely.

Bull nose 68 need not be uniform about tube 22. It may be ridged or intermittent or some other shape or arrangement provided that it causes some degree of deformation about the interface of tube 22 and bulkhead 24 and the general area 50 to maintain a fluid seal between tube 22 and bulkhead 24. Bull nose 68 may itself be tapered and may be somewhat conical in shape so that it encourages deformation of bulkhead 24 in area 50 without cracking, breaking or undesirably deforming bulkhead 24 and/or tube 22. Care should be taken not to deform bulkhead 24 to the extent that bulkhead area 50 becomes cracked or breaks or otherwise damages the structural integrity of tube end 42 or other parts of bulkhead 24. Bull nose 68 may be a series of intermittent projections, which may be evenly spaced or sporadically spaced, on tube holder 58 so that they deform at least portions in or adjacent to area 50.

Following striking by bull nose 68, tube holder parts 58a and 58b may separate, leaving tube 22 attached to bulkhead 24. After the striking step, passage 26 may be formed by a drill or other appropriate apparatus (not shown). However, passage 26 is preferably made prior to the attachment of the conduit to the fitting, either before or after rebate 32 is made in bulkhead 24.

As can be seen, one or more steps of the present method of manufacture described herein may be readily automated, which may serve to reduce the time and/or cost associated with joining the conduit to the fitting.

In this embodiment, various parts are moved relative to one another. It is not necessary that one part moves and the other is held stable. In alternative embodiments, parts that are stable or fixed in other embodiments may be moved while moving parts in other such embodiments may be held in a fixed position. Alternatively, two or more parts may be moved relative to one another to impart the forces desired to assemble the components of a given embodiment. In the present example, various components of the apparatus are activated using pneumatic cylinders. Various other activation devices or methods may be used such as hydraulics, electronics, or even the manual movement of parts. In some circumstances appropriate modifications of the apparatus may need to be made: For example, if tube 22 and bulkhead 24 are assembled manually then suitable tools may need to be employed, which tools may differ from those of the present examples.

The above-described arrangement and method may be used to reduce or eliminate the need for threaded fittings, which may include nuts or bolts, to join the conduit to the fitting. This arrangement also generally does not require an o-ring and/or a threaded fitting, which may include a bolt, to engage and deform tube end 42. Avoiding or reducing the use of additional components, such as O-rings and threaded fittings, may reduce the amount of machining required to join the conduit and fitting. Tube 22 may conveniently be bent to have one or more angles at multiple places to connect a gas valve to a manifold. Assemblies that require threaded connections may also require a configuration taking up a larger volume. This may make the connection of such assembly to another assembly or sub-assembly more difficult and/or time consuming. Similarly, brass or stainless steel compression fittings known in the art are not required. The need to deburr a tube to be connected with the compression fitting may be reduced or eliminated as well.

Conduit end 42 may be configured to have a barb to permit insertion in to rebate 32 but to discourage removal thereof (not shown). Likewise, rebate 32 by include a lip or catch to engage the barb to inhibit removal of conduit end 42 therefrom.

Structures that may be connected in the manner described herein are not necessarily limited to the examples or embodiments provided. FIGS. 13, 14, 15, 16, 17, 18, 19 and 27 illustrate various alternative embodiments of rebate 32. Not all embodiments of rebate 32 will necessarily provide a sufficient seal when combined with each and every embodiment of conduit 22. The embodiments of rebate 32 described herein may generally provide a satisfactory connection when combined with a conduit such as tube 22 as first described herein. In some embodiments, it may be preferable to reduce any sharp comers to lower stress concentration.

FIG. 13 illustrates a rebate 32f. Rebate 32f is generally disposed in a conically inward direction (as opposed to rebate 32f which is generally disposed in a conically outward direction). The rebates in each of these examples are intended to impart or encourage some degree of deformation in a conduit end such as tube end 42. FIG. 14 illustrates a somewhat conical shape having curved sides. FIG. 27 illustrates a somewhat stepped-conical rebate 32p.

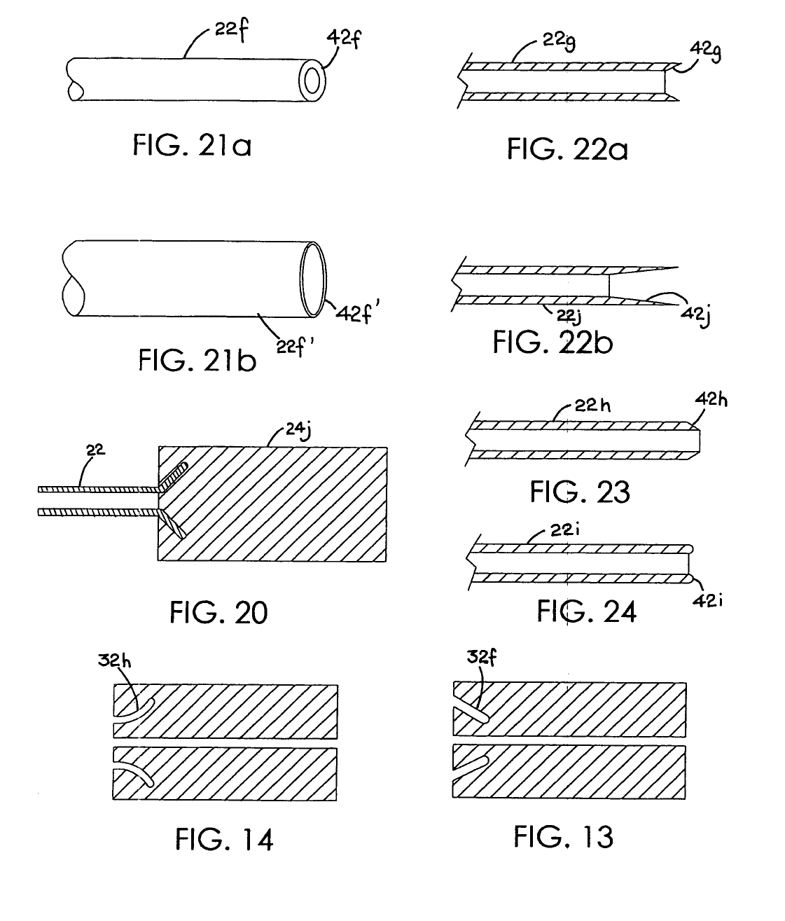

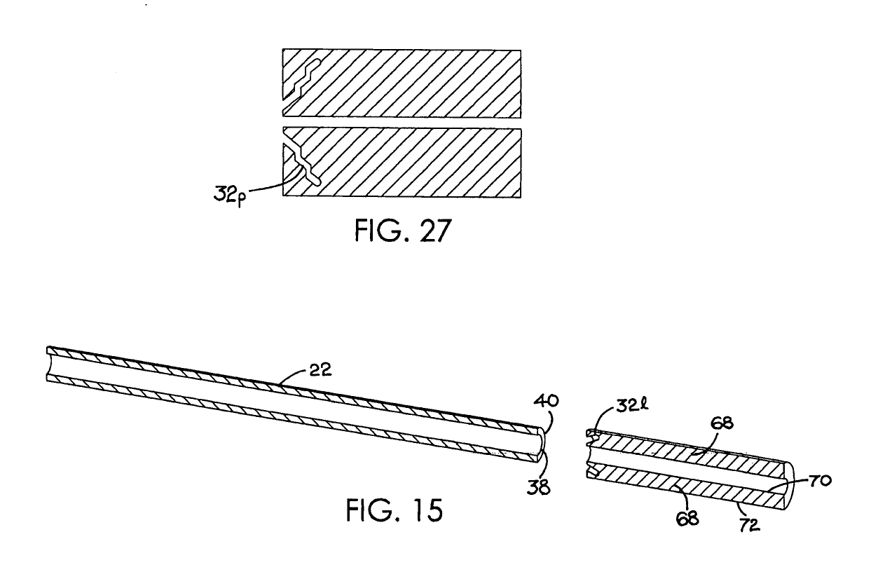

FIG. 15 includes a second conduit 68 having an inner diameter 70, which is generally less than an inner diameter 38 of tube 22; and a conduit outer diameter 72 which may be generally larger than an outer diameter 40 of tube 22. The difference in diameters 70 and 72 provides sufficient material in tube 68 to define a rebate 32i. Many of the other configurations described herein for rebates 32 and conduits 22 may be employed for this embodiment, as appropriate.

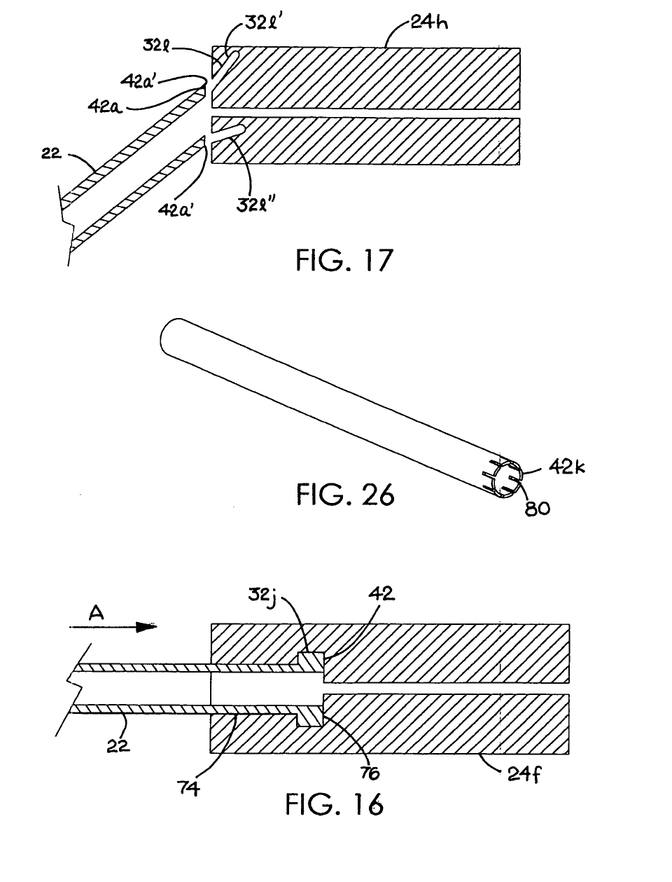

FIG. 16 includes a widened passage 74 in a bulkhead 24f. Tube 22 is introduced into widened passage 74 and encounters a wall 76 of rebate 32j. Wall 76 inhibits further insertion of tube end 42. As force is applied to tube 22 in direction A, tube end 42 becomes deformed and engages portions of rebate 32j to retain tube 22 therein and to provide a fluid seal between tube 22 and bulkhead 24f. If tube 22 will not be subject to significantly high temperatures, then it may be made of a plastic in this and other embodiments. For example, in the embodiment shown, tube 22 may be melted to deform.

FIG. 17 illustrates a rebate defining an irregular shape. Portions of rebate 321 include rebate portion 32L′ and rebate portion 32L″. In this example, conduit 22 has an angled conduit end 42a. A leading portion 42a′ is introduced into rebate portion 32L′, and, similarly, conduit end portion 42a″ is introduced into rebate portion 32L″. Due to the geometry of this configuration, portions of bulkhead 24h that define rebate 32L inhibit insertion of tube 22 into rebate 32L, causing deformation in tube end 42a. In this embodiment, tube end 42a, including end portions 42a′ and 42a″ may be introduced to rebate 32L at approximately the same time. In such case, tube end 42a is introduced at an angle relative to direction A. Alternatively, tube end 42a may be introduced in the same manner as shown in FIG. 3 in direction A.

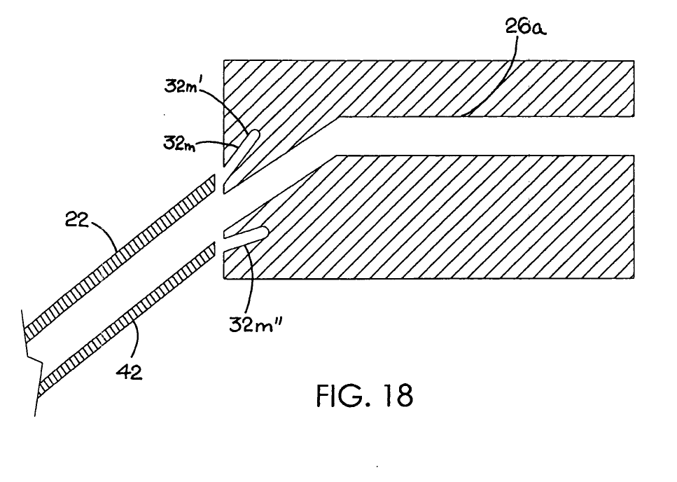

FIG. 18 illustrates an embodiment that is similar to that shown in FIG. 17. The embodiment of FIG. 18 includes a rebate 32m having rebate portions 32m′ and 32m″. Tube 22 has an end 42, configured as described above. Passage 26a has a configuration different than that of passage 26.

In general, the particular configuration of passage 26 may be varied, as required, and is not limited to the embodiments shown herein.

FIG. 19 illustrates a further alternative embodiment of rebate 32, labeled as 32o. In this embodiment, bulkhead 24g has portions defining a widened passage 78 for receiving tube 22. Widened passage 78 is configured such that there is a limited or minimal amount of play between inserted tube 22 and walls of widened passage 78. In a manner similar to that described for the other embodiments, tube end 42 is inserted into widened passage 78 and engages portions of bulkhead 24g defining rebate 32o and is deformed to provide a seal.

FIG. 20 provides an example of the conduit assembly wherein the bulkhead 24j does not include a passage. In this configuration, bulkhead 24j, or other suitable part, acts as a cap or stop to the end of conduit 22. This arrangement may be used to cap a pipe or tube to inhibit the flow of a fluid within the conduit or tube 22.

FIGS. 21, 22, 23, 24, 25 and 26 illustrate alternative embodiments of tube 22. As with the descriptions and examples provided for the other elements of conduit assembly 20, these are merely examples of possible variations of tube 22.

FIGS. 21A and B show tube 22f and 22f having an alternative inner and outer diameter at at least ends 42f and 42f, respectively. In FIGS. 22 A and B, tubes 22g and 22j respectively include a tube end 42g having angled or sculpted projections or points. The tube 22h of FIG. 23 shows tube end 42h having tapered portions. Tube 22i of FIG. 24 includes an end 42i that includes a rounded portion. FIG. 26 shows a tube end 42k having at least one recess or indent 80. Such configuration may facilitate deformation of tube end 42k when inserted into a rebate of fitting.

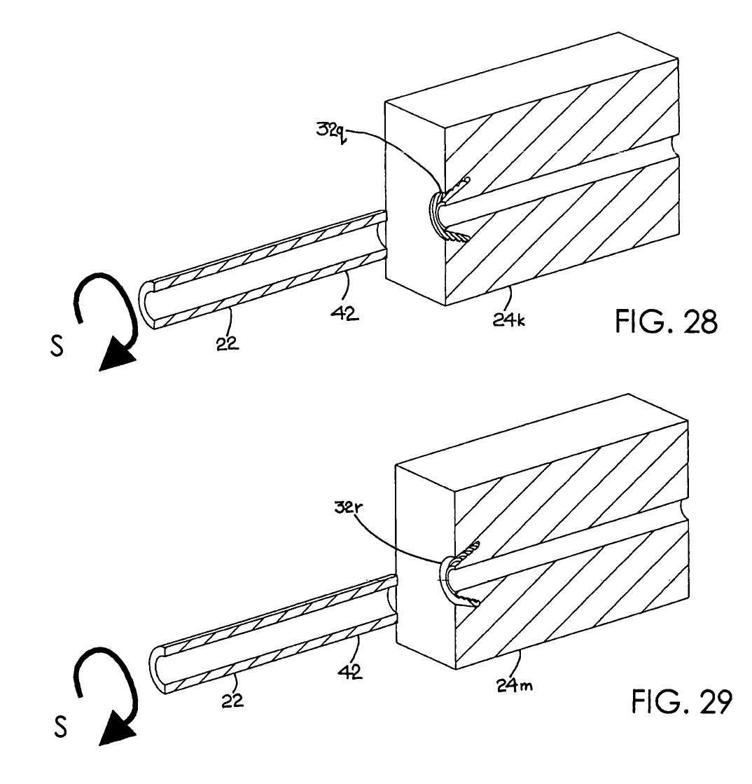

FIGS. 28 and 29 illustrate a further alternative embodiment. Bulkhead 24K includes a rebate 32q having threads on at least a portion of the rebate outer diameter surface. When conduit 22 is inserted in the manner described herein while being rotated in direction S, a seal may be formed between Bulkhead 24K and conduit 22. Conduit 22 may also be inserted while being rotated in a direction opposite to S. The embodiment illustrated in FIG. 29 is similar except that threads are located on portions of an inner diameter surface of rebate 32R of Bulkhead 24M. Alternatively, threads may be included on both inner and outer diameter surfaces, and/or on inner and outer diameter surfaces of conduit 42. An embodiment may be devised of a combination of one or more of the foregoing features, including having threads which are engaged in a direction opposite to S. The threads may advantageously prevent the tube from backing out. The positive threads on the rebate cut into the internal diameter (or outer diameter) of conduit 22 and may form negative threads on conduit 22.

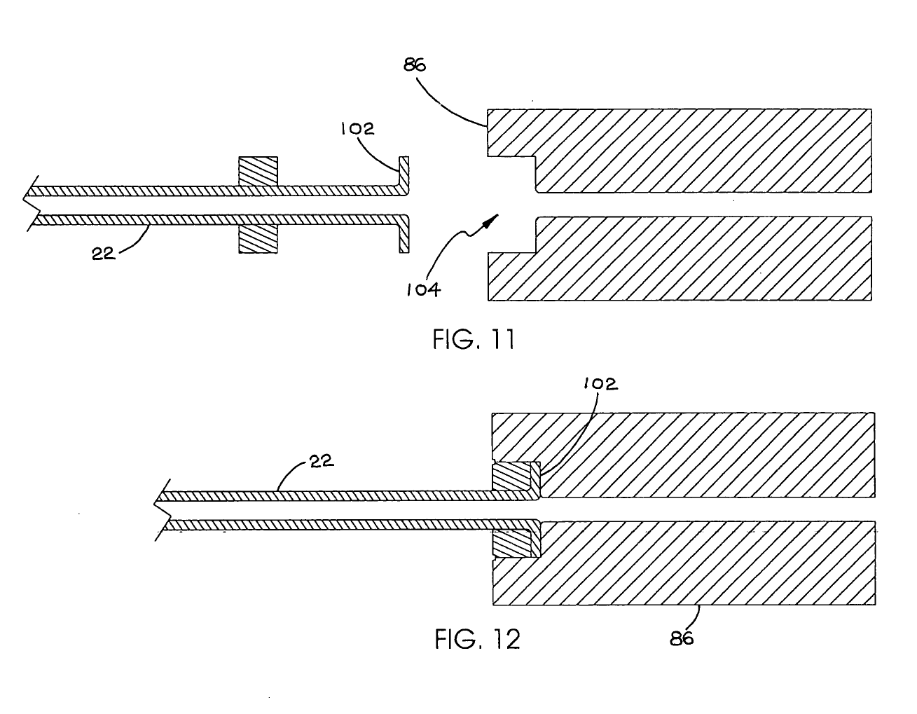

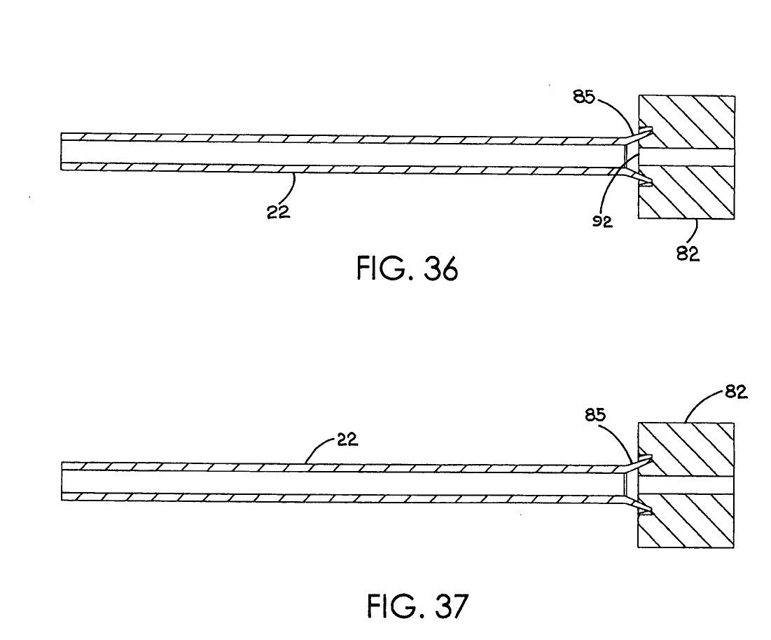

FIGS. 11 and 12 and 31 to 42 illustrate another embodiment of the invention. One or more aspects of the embodiments described above may be applied or combined with one or more aspects of the present embodiment. Similarly, aspects of the present embodiment may be combined with or applied to the previously described embodiments.

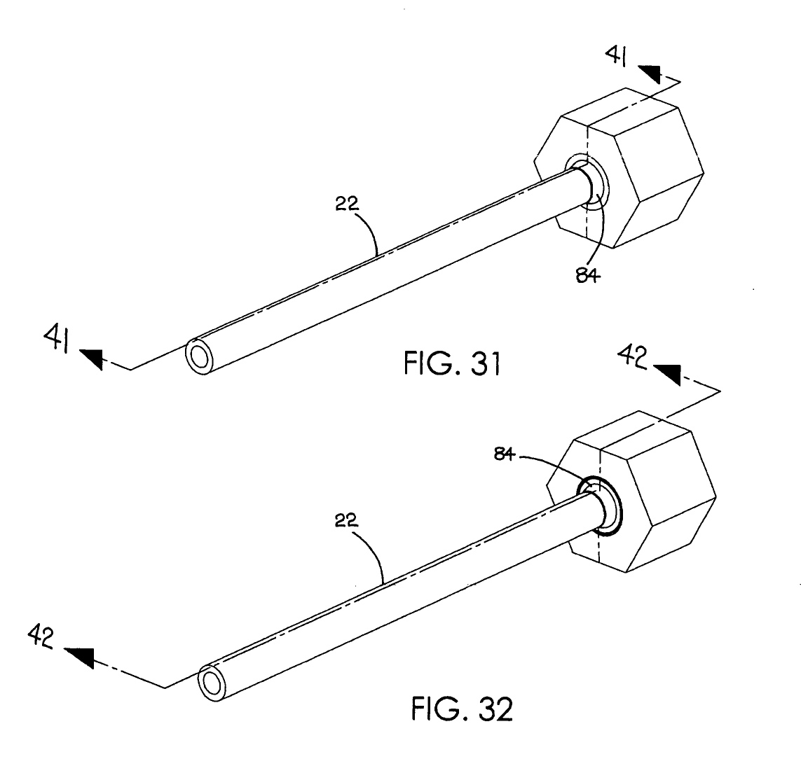

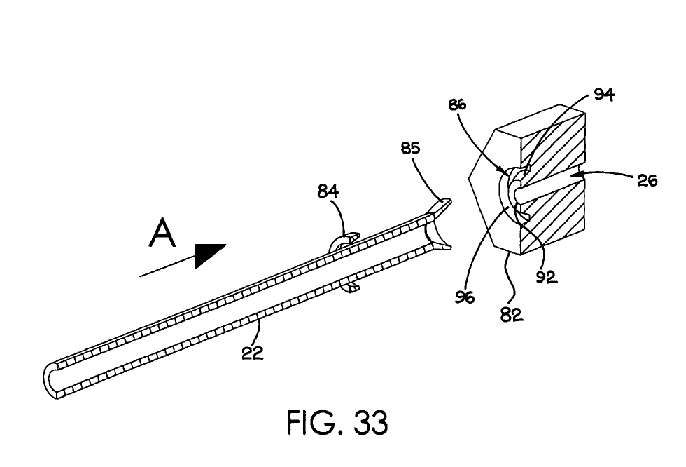

FIG. 31 illustrates conduit 22 and an alternative fitting assembly including bulkhead or bulkhead adapter 82. The general overall shape and size of bulkhead 82 may be similar to that of bulkhead 24. The illustrated embodiment includes a retainer which may be in the nature of a wedge or ring 84. Conduit 22 may be inserted into a rebate 86 of bulkhead 82 and ring 84 may be placed about the interface of an end 85 of conduit 22 and bulkhead 82. At least a portion of ring 84 is positioned to wedge, and possibly deform, into rebate 86 of bulkhead 82 (see FIG. 33, for example). A force may then be applied to ring 84 to encourage further retention therein. Ring 84 may deform, at least partially, within rebate 86 to be retained therein. However, ring 84 does not need to deform to be retained. A seal resistant to the transmission of fluids may then be formed between conduit 22 and bulkhead 82.

By employing a ring, wedge or other retaining feature in this embodiment, costs may be reduced. For instance, the costs of forming, for example, by milling, bulkhead rebate 86 may be reduced.

Referring to FIG. 33, conduit 22 may be inserted into bulkhead 82 in the general direction A. Rebate 86 may be defined within bulkhead 82 to correspond to a portion of combined conduit end 85 and ring 84. Rebate 86 may be inwardly tapered, becoming progressively narrower. Conduit end 85 may be similarly tapered, being progressively thinner towards the terminus of conduit end 85. Ring 84 may also be similarly tapered so that, when it is located adjacent to conduit end 85, the combined shape of ring 84 and conduit end 85 is about the same, and may be slightly larger than or smaller than, the shape of rebate 86. Alternatively, ring 84, conduit end 85 and rebate 86 may be machined to precisely engage. Ring 84 and conduit end 85 may thereby be together wedged within rebate 86.

Engagement between at least two or more of ring 84, conduit end 85 and bulkhead 82 may be encouraged by heating bulkhead 82 and/or cooling one or both of ring 84 and conduit end 85. Once two or more of the components are at different temperatures, they are assembled. As the components warm (or cool) to the ambient temperature, they marginally expand (or shrink) to engage the adjacent components.

An exposed surface of ring 84 may be flush, raised or receded relative to an outside surface of bulkhead 82. Conduit 22, retaining ring 84 and bulkhead 82 may be press-fitted together. An sufficient seal may be obtained between two or more of conduit end 85, ring 84 and bulkhead 82 by reducing or eliminating variation in the mating surfaces of these three elements.

Ring 84 may be dimensioned so that it may pass over conduit 22 until it abuts conduit end 85. Ring 84 may be made of a material similar to that of conduit 22 and bulkhead 82, and may be made of any of the materials described for conduit 22 and bulkhead 24. Similarly, bulkhead 82 and conduit end 85 may be made of any of the materials described herein. Ring 84 may also be made of a different material than conduit 22, conduit end 85, and bulkhead 82. Furthermore, each of ring 84, conduit 22, conduit end 85 and bulkhead 82 may be made of different materials. Ring 84 may also be made of a deformable material to permit it to deform within rebate 86 to provide a seal. Ring 84 may be formed as one piece or may be made in two or more pieces that may be installed either sequentially or concurrently.

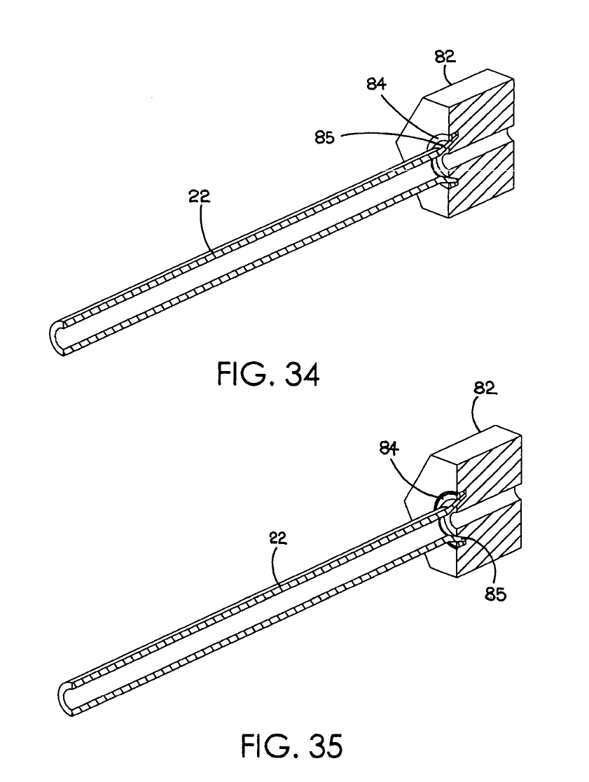

Referring additionally to FIGS. 34 to 37, conduit 22 may be inserted into rebate 86 either before or concurrently with ring 84. Initially, ring 84 and conduit end 85 may be wedged or frictionally retained within rebate 86. This retention may be encouraged by applying a force to ring 84. This arrangement, depending on pressures within conduit 22 and bulkhead 82, and the materials used, may be sufficient to provide a satisfactory seal against leakage of a fluid. However, a seal resistant to greater pressures may be obtained by applying a greater force to ring 84 and/or conduit 22 to encourage further frictional retention within bulkhead 82. A force sufficient to cause deformation of the components, to be retained within rebate 86, may also be applied.

In a similar manner to the embodiments described earlier, one or more portions of ring 84 and/or conduit 22 may be deformed or crimped to further seal the interface between conduit end 85, ring 84 and bulkhead 82. As shown in FIGS. 35 and 37 portions of one or both of bulkhead 82 and ring 84 may be deformed. In the illustrated embodiment, a periphery of ring 84 at its interface with bulkhead 82 may be deformed as well as adjacent portions of bulkhead 82 adjacent a periphery of ring 84.

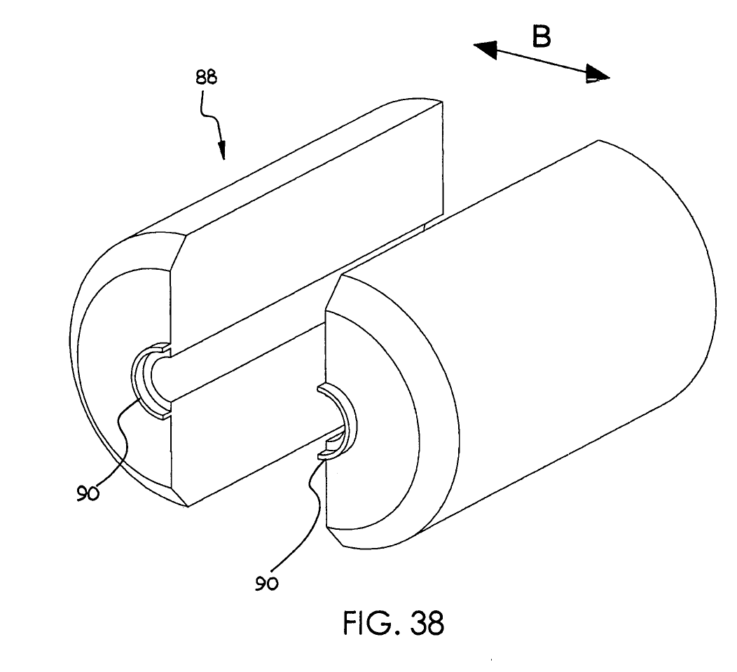

Such crimping may be achieved in a manner similar to that described earlier. For example, a tube holder 88 may be configured as shown in FIG. 38 to engage conduit 22. Holder 88 may have a bullnose 90 configured to apply pressure to one or more of conduit end 85, ring 84 and bulkhead 82, to cause deformation thereof.

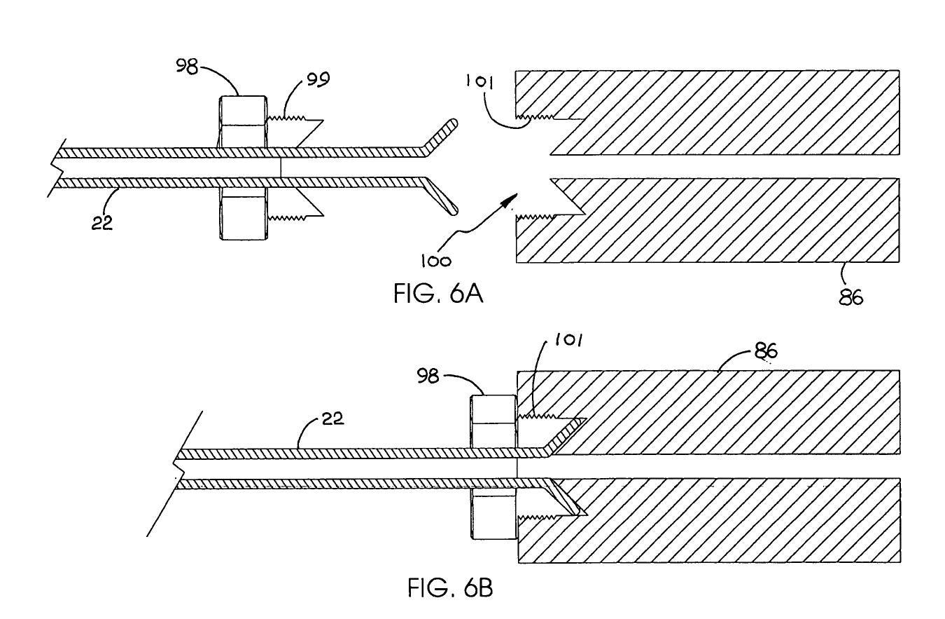

Referring to FIGS. 6A and 6B, instead of, or in addition to, crimping or swaging, ring 84 may be threaded (similar to FIGS. 28 and 29 illustrated for another embodiment), glued or welded into bulkhead 82. For example, ring 98 may include threads 99 and rebate 100 may include threads 101 for receiving threads 99. Ring 98 may be turned, for example by hand or tool, and tightened so that ring 98 encourages tube end 85 to form a fluid seal with bulkhead 82. Alternatively, or additionally, threads 99 and 101 may co-operate to form a fluid seal between conduit 22 and bulkhead 85.

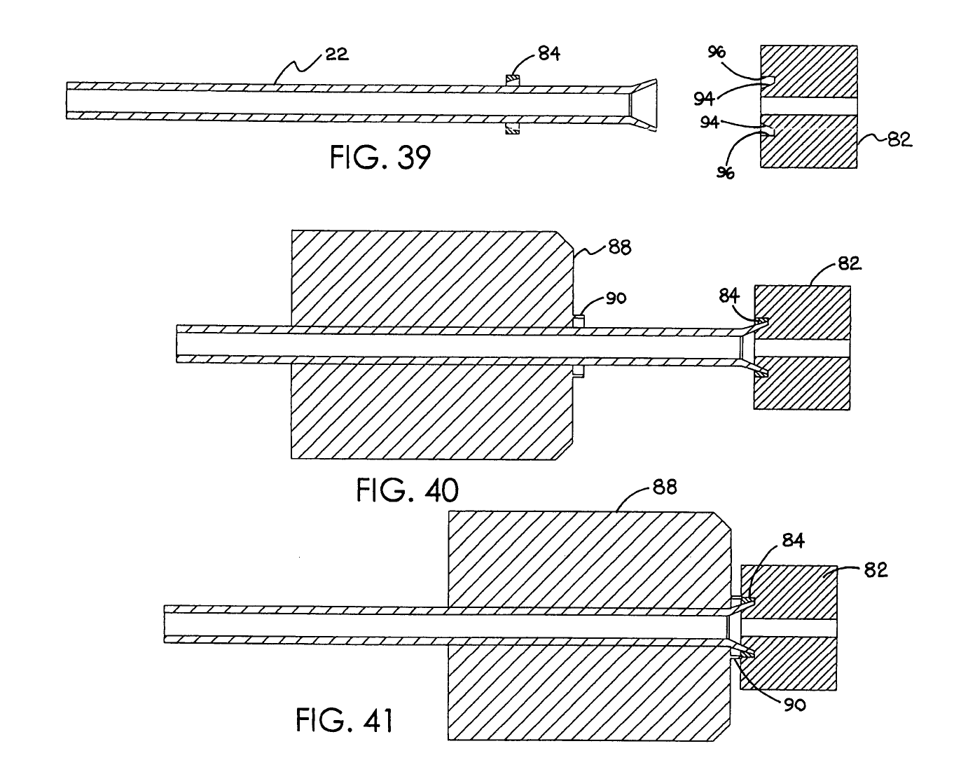

FIGS. 39 to 41 illustrate the steps in combining conduit 22 with bulkhead 82. Conduit end 85 may be placed within rebate 86 and ring 84 may be positioned within rebate 86 adjacent tube end 85. Tube holder 88 may then be encouraged to move along or about conduit 22 so that bullnose 90 applies a force, for example by striking, against portions of bulkhead 82 and ring 84 adjacent the interface there between. The resulting deformation of one or more of ring 84, bulkhead 82 and tube end 85, encourages conduit 22 to be retained by bulkhead 82, and encourages the formation of a seal that is resistant to the leakage of fluids.

It will be appreciated that the particular sizing and dimensions of rebate 86, conduit end 85 and ring 84 may be varied so long as ring 84 wedges, or otherwise encourages the retention of conduit end 85 within rebate 86.

Conduit end 85 may be formed as a flared, or expanded end, and may have a taper therein. An internal surface of ring 84 may be formed as a female generally conical or frusto conical feature. This feature may be pre-machined in retaining ring 84 and configured to mate with an outside surface of flared tubing end 85. Rebate 86 may define a male generally conical or generally frusto conical feature 92.

Rebate 86 may include a radially inner surface 94 and a radially outer surface 96. As noted, inner surface 94 may approximately correspond to conduit end 85. While inner surface 94 may be generally co-axial with conduit 22, it is preferably angled radially outwardly as rebate 82 progresses into bulkhead 82. Outer surface 96 may be generally opposed to inner surface 94 and may define a generally cylindrical surface as shown in FIG. 33, for example. Alternatively, outer surface 96 may be angled radially inwardly as rebate 86 progresses into bulkhead 82.

Alternatively, one or both of outer surface 96 and inner surface 94 may have a generally hexagonal, square, rectangular, oval, or any regular or irregular polygonal profile (not shown) rather than the generally circular profile as shown for example in FIG. 33. Ring 84 and conduit end 85 may be configured to be complimentary to such alternative shapes in the manner discussed above in the context of the illustrated embodiment.

Feature 92 may be pre-machined in bulkhead 82 adapter and configured to mate with the inner surface of flared tubing end 85. An orifice or passage 26 may be drilled under a second manufacturing process to intersect male conical feature 92. Passage 26 may be in fluid communication with conduit 22 so that it may channeling fluid such as a liquid or a gas.

Conduit end 85 may be angled away from (or towards) a longitudinal axis of conduit 22 so that it may cooperate with ring 84 to discourage removal of conduit 22 from bulkhead 82. If conduit end 85 angles toward a longitudinal axis of conduit 22, then a ring or other wedging or retention feature may need to be installed by insertion through conduit 22. Placement and striking of such ring may prove difficult depending upon the diameter of conduit 22.

FIG. 42 provides somewhat specific dimensions of an embodiment of bulkhead 82. These dimensions and the shape defined by rebate 86 may be similar to those described for other embodiments, and may also be varied in a manner similar to that described for the other embodiments.

Referring to FIGS. 11 and 12, a further alternative embodiment is shown. Conduit 22 may have an end 102 having an approximately 90 degree angle formed therein. Rebate 104 may be configured to correspond to end 102. In particular, rebate 104 may be formed to have a generally rectangular longitudinal cross-section for receiving end 102. A ring 106 having a cross-section substantially similar to rebate 104 may be configured to pass or slide over conduit 22 to be received by rebate 104 when conduit end 102 is placed therein. Ring 106 may slidingly engage, and may frictionally engage, sides defining rebate 104. If ring 106 slidingly engages rebate 104, then one or more of ring 106, bulkhead 86, and conduit 22 may be deformed to retain conduit end 102 within rebate 104 in the manner described for the other embodiments. Such deformation may take the form of crimping, swaging, binding, striking or some other deformation shown as 108. Similarly, if ring 106 is frictionally retained within rebate 104 one or more elements of the assembly may be deformed to encourage retention of end 102 within rebate 104.

The various embodiments of tube 22 that have been described are not intended to be limiting, but are intended to provide examples of tube configurations that may be used in conjunction with at least one or more of the embodiments of the conduit assembly 20 described herein. The various embodiments of the different elements of the conduit assembly may require that the apparatus used to manufacture such alternative embodiments be modified as appropriate. For example, to the extent that the bulkhead is deformed in area 50, modifications to bull nose 68 may be required.

For example, the dimensions provided herein for the various embodiments of the inventions described may be varied, and may be advantageously varied to satisfy at least the following operating conditions: i) the operating temperature of the assembly 20; ii) the fluid flow rate requirements; iii) the type of fluid to be carried; and iv) the pressure to be contained by the assembly 20. Changes in these conditions may require changes in the dimensions disclosed herein.

While the foregoing invention has been described in some detail for purposes of clarity and understanding, it will be appreciated by one skilled in the art, that numerous modifications, variations, and adaptations may be made to the particular embodiments of the invention described above without departing from the scope of the invention, which is defined in the following claims.

What is claimed is:

1. A conduit assembly comprising:
a retainer;
a fitting;
said fitting having an accommodation;
a conduit having an end axially inserted into said accommodation;
said accommodation having a portion defining a profile of varying radius as a function of axial location;
said end conforming to a radially inner surface of said accommodation;
said retainer conforming to a radially outer surface of said accommodation and to said end to retain said end within said accommodation;

2. The assembly of claim 1, wherein said outer surface has a generally round cross-section to define generally cylindrical shape, and said radially inner surface has said profile of varying radius.

3. The assembly of claim 1, wherein said accommodation includes an opening for receiving said end, and said radius generally increases along said axis of insertion along the direction of insertion.

4. The assembly of claim I, wherein said radius varies orthogonally to said axis.

5. The assembly of claim 1, wherein said retainer is threaded and said accommodation defines threads complimentary to said retainer threads for engaging said retainer.

6. The assembly of claim 1, wherein said retainer is frictionally retained within said accommodation.

7. The assembly of claim 3, wherein said accommodation is a rebate and said radially inner surface is conically shaped being narrower adjacent said opening, and said end is flared to conform to said conical inner surface.

8. The assembly of claim 7, wherein said radially inner surface is frusto-conically shaped.

9. The assembly of claim 1, wherein said retainer is a ring that is tapered, being narrower at a leading end of insertion thereof.

10. The assembly of claim 1, wherein said ring is a wedge.

11. The assembly of claim 1, wherein said conduit has a diameter in the range of ⅛ of an inch to 1.5 inches.

12. The assembly of claim 1, wherein said fitting further defines a passage therein, said passage being located for fluid communication with said conduit.

13. The assembly of claim 1, wherein said conduit is a tube.

14. The assembly of claim 1, wherein said assembly is deformed adjacent an interface of said retainer and said fitting to retain said fitting within said accommodation.

15. The assembly of claim 1, wherein said assembly is swaged adjacent an interface of said retainer and said fitting to retain said fitting within said accommodation.

16. The assembly of claim 1, wherein said assembly is indented adjacent an interface of said retainer and said fitting to retain said fitting within said accommodation.

17. The assembly of claim 1, wherein at least one of said conduit end, said retainer, and said fitting are made of at least one material selected from the group consisting of: aluminum, aluminum alloy, stainless steel copper, brass and mild steel.

18. The assembly of claim 1, wherein the fitting is a bulkhead adapter.

19. A conduit assembly comprising:
a conduit having an end made of a ductile material;
a fitting;
said fitting having an accommodation;
said end being axially inserted into said accommodation;
said accommodation being shaped to compel deformation of said end during insertion thereof;
said accommodation having a portion defining a profile of varying radius as a function of axial location; and
said end being deformed to conform to said profile to be retained within said accommodation.

20. The assembly of claim 19, wherein said accommodation includes an opening for receiving said end, and said radius generally increases along said axis of insertion along the direction of insertion.

21. The assembly of claim 19, wherein said assembly is deformed adjacent an interface of said conduit and said fitting to retain said fitting within said accommodation.

22. The assembly of claim 19, wherein said assembly is swaged adjacent an interface of said conduit and said fitting to retain said fitting within said accommodation.

23. The assembly of claim 19, wherein said assembly is indented adjacent an interface of said conduit and said fitting to retain said fitting within said accommodation.

24. The assembly of claim 19, wherein said fitting is made of a material that is harder than the material of said conduit end.

25. The assembly of claim 20, wherein said accommodation defines a conically shaped rebate.

26. The assembly of claim 19, wherein said conduit end is made from a material selected from the group consisting of: aluminum, aluminum alloy, stainless steel copper, brass, mild steel and plastic.

27. A conduit assembly comprising:
a retainer;
a fitting;
said fitting having an accommodation;
a conduit having an end axially inserted into said accommodation;
said accommodation having a profile of constant radius as a function of axial location;
said end extending proud of an outer surface of said conduit;
said retainer conforming to a radially outer surface of said accommodation and to said conduit outer surface; and
said assembly being deformed adjacent an interface of said retainer and said fitting to retain said end within said accommodation.

28. The assembly of claim 27, wherein said assembly is swaged adjacent an interface of said conduit and said fitting to retain said fitting within said accommodation.

29. The assembly of claim 27, wherein said assembly is indented adjacent an interface of said conduit and said fitting to retain said fitting within said accommodation.

30. A method of joining a conduit to a fitting, said conduit having an end extending proud of an outer surface of said conduit, and the fitting having an accommodation, said method comprising the steps of:
inserting said conduit into said accommodation;
placing into said accommodation a retainer which conforms to a radially outer surface of said accommodation and to said conduit outer surface; and
deforming said assembly adjacent an interface of said retainer and said fitting to retain said end within said accommodation.

31. A method of joining a cylindrical conduit to a fitting, the fitting having a conically shaped accommodation, said accommodation having a portion defining a profile of varying radius as a function of axial location, said method comprising the steps of:
axially inserting said conduit into said accommodation to deform said conduit end to a conical shape; and
deforming said assembly adjacent an interface of said conduit and said fitting to retain said end within said accommodation.
